(19) United States
(12) Patent Application Publication
(10) Pub. No.: US 2025/0378571 A1
(43) Pub. Date: Dec. 11, 2025

(54) AIMING METHOD FOR VEHICLE-MOUNTED CAMERA AND NON-TRANSITORY COMPUTER-READABLE STORAGE MEDIUM

(71) Applicant: HONDA MOTOR CO., LTD., Tokyo (JP)

(72) Inventors: Hiroyuki NAKASHIMA, Tokyo (JP); Satomi MASUDA, Tokyo (JP); Daiki YONEYAMA, Tokyo (JP); Hiroki OSHIYAMA, Kanagawa (JP)

(21) Appl. No.: 19/184,426

(22) Filed: Apr. 21, 2025

(30) Foreign Application Priority Data
Jun. 6, 2024 (JP) 2024-092424
Nov. 6, 2024 (JP) 2024-194212

(51) Int. Cl. G06T 7/70; G06V 20/56

(52) U.S. Cl. CPC G06T 7/70; G06V 20/56; G06T 2207/30244

(57) ABSTRACT

An aiming method for a vehicle-mounted camera includes performing relative aiming. The relative aiming includes: a step of acquiring a first camera image by causing a vehicle-mounted camera whose attitude is known to capture an image of a target; a step of acquiring a second camera image by causing a vehicle-mounted camera to be aimed, which is disposed such that an image capturing range of the vehicle-mounted camera to be aimed overlaps an image capturing range of the vehicle-mounted camera whose attitude is known, to capture an image of the target; and a step of estimating an attitude of the vehicle-mounted camera to be aimed based on the first camera image, the second camera image, and an attitude of the vehicle-mounted camera whose attitude is known.

### TECHNICAL FIELD

The present invention relates to an aiming method for a vehicle-mounted camera and an aiming program (stored in a non-transitory computer-readable storage medium).

### BACKGROUND ART

In recent years, taking into account people in vulnerable situations among traffic participants, efforts have been actively made to provide access to sustainable transportation systems for such people. Toward its realization, research and development for further improving the safety and convenience of traffic through development of driving assistance technology are attracting attention.

For example, there is known a vehicle configured to recognize objects or the like outside the vehicle based on an image captured by a vehicle-mounted camera and to execute driving assistance control based on the recognition result. To use the image captured by the vehicle-mounted camera in the driving assistance control, it is necessary to accurately estimate the attitude and position of the vehicle-mounted camera. Therefore, a technology for aiming (calibrating) the vehicle-mounted camera has been developed.

For example, JP2009-294109A discloses a calibration device including an image acquisition means for acquiring an image of a jig provided with multiple markers by using a camera to be calibrated, and a calculation means for calculating the installation position and angle of the camera based on the positions of the markers in the image.

The conventional technology mentioned above assumes that the jig is disposed on a flat surface (see paragraph [0021] of JP2009-294109A). Therefore, there is a significant restriction on a space in which calibration of the camera is performed with respect to the ground shape. The conventional technology mentioned above also assumes that the ground appears in the image captured by the camera. Therefore, a wide space is necessary to perform calibration of the camera.

### SUMMARY OF THE INVENTION

In view of the foregoing background, a primary object of the present invention is to provide an aiming method for a vehicle-mounted camera and an aiming program (stored in a non-transitory computer-readable storage medium) which can relax the restriction on the size of the space in which aiming of the vehicle-mounted camera is performed and the ground shape in such a space.

To achieve the above object, one aspect of the present invention provides an aiming method for a vehicle-mounted camera (Cp), the aiming method comprising performing relative aiming, wherein the relative aiming comprises: a step (ST2, ST12) of acquiring a first camera image (I₁) by causing a vehicle-mounted camera whose attitude is known to capture an image of a target (TB); a step (ST3, ST13) of acquiring a second camera image (I₂) by causing a vehicle-mounted camera to be aimed, which is disposed such that an image capturing range of the vehicle-mounted camera to be aimed overlaps an image capturing range of the vehicle-mounted camera whose attitude is known, to capture an image of the target; and a step (ST4, ST15) of estimating an attitude of the vehicle-mounted camera to be aimed based on the first camera image, the second camera image, and an attitude of the vehicle-mounted camera whose attitude is known.

According to this aspect, the target can be set at any position where the image of the target can be captured by both the vehicle-mounted camera whose attitude is known and the vehicle-mounted camera to be aimed. Therefore, it is possible to relax the restriction on the size of the space in which aiming of the vehicle-mounted camera is performed and the ground shape in such a space. Also, by adopting the relative aiming, the requirement for the positional accuracy of the target can be relaxed. Therefore, the setting process of the target can be simplified.

In the above aspect, multiple times of the relative aiming may be performed consecutively, with the vehicle-mounted camera whose attitude is known being a starting point.

According to this aspect, with multiple times of relative aiming, it is possible to estimate the attitude of multiple vehicle-mounted cameras to be aimed.

In the above aspect, the aiming method may comprise: calculating a first estimated value (T_{CpA}) of the attitude of the vehicle-mounted camera to be aimed by performing the relative aiming clockwise with respect to the vehicle-mounted camera to be aimed, calculating a second estimated value (T_{CpB}) of the attitude of the vehicle-mounted camera to be aimed by performing the relative aiming counterclockwise with respect to the vehicle-mounted camera to be aimed, and estimating the attitude of the vehicle-mounted camera to be aimed based on the first estimated value and the second estimated value.

According to this aspect, even in the case where multiple times of relative aiming are performed consecutively, the attitude of the vehicle-mounted camera to be aimed can be estimated with good accuracy based on the two estimated values.

In the above aspect, in the step of estimating the attitude of the vehicle-mounted camera to be aimed, either the first estimated value or the second estimated value may be selected according to a predetermined rule.

According to this aspect, the attitude of the vehicle-mounted camera to be aimed can be estimated with good accuracy by a simple process that does not include averaging or the like.

In the above aspect, in the step of estimating the attitude of the vehicle-mounted camera to be aimed, one of the first estimated value and the second estimated value that is calculated with a fewer times of the relative aiming may be selected.

In the case where multiple times of relative aiming are performed consecutively, an estimation error of the attitude of the vehicle-mounted camera to be aimed accumulates as the number of times of relative aiming increases. According to the above aspect, by selecting one of the first estimated value and the second estimated value that is calculated with a fewer times of the relative aiming, the influence of the estimation error as mentioned above can be reduced. Therefore, the attitude of the vehicle-mounted camera to be aimed can be estimated even more accurately.

In the above aspect, in the step of estimating the attitude of the vehicle-mounted camera to be aimed, weighted averaging may be performed on the first estimated value and the second estimated value.

According to this aspect, with the weighted averaging, the attitude of the vehicle-mounted camera to be aimed can be estimated with good accuracy.

In the above aspect, in the weighted averaging, a weight (WA, WB) of one of the first estimated value and the second estimated value that is calculated with a fewer times of the relative aiming may be made greater than a weight of another of the first estimated value and the second estimated value.

In the case where multiple times of relative aiming are performed consecutively, an estimation error of the attitude of the vehicle-mounted camera to be aimed accumulates as the number of times of relative aiming increases. According to the above aspect, by setting the weight of one of the first estimated value and the second estimated value that is calculated with a fewer times of relative aiming to be greater than the weight of the other of the first estimated value and the second estimated value, the influence of the estimation error as mentioned above can be reduced. Therefore, the attitude of the vehicle-mounted camera to be aimed can be estimated even more accurately.

In the above aspect, the step of estimating the attitude of the vehicle-mounted camera to be aimed may comprise: a step of estimating a relative attitude between the vehicle-mounted camera whose attitude is known and the target based on the first camera image; a step of estimating a relative attitude between the vehicle-mounted camera to be aimed and the target based on the second camera image; a step of estimating a relative attitude between the vehicle-mounted camera whose attitude is known and the vehicle-mounted camera to be aimed based on the relative attitude between the vehicle-mounted camera whose attitude is known and the target and the relative attitude between the vehicle-mounted camera to be aimed and the target; and a step of estimating the attitude of the vehicle-mounted camera to be aimed based on the relative attitude between the vehicle-mounted camera whose attitude is known and the vehicle-mounted camera to be aimed and the attitude of the vehicle-mounted camera whose attitude is known.

According to this aspect, the attitude of the vehicle-mounted camera to be aimed can be estimated with good accuracy based on the first camera image, the second camera image, and the attitude of the vehicle-mounted camera whose attitude is known.

In the above aspect, in the step of estimating the attitude of the vehicle-mounted camera to be aimed, nonlinear optimization may be performed directly on an external parameter matrix of the vehicle-mounted camera to be aimed.

According to this aspect, by performing nonlinear optimization directly on the external parameter matrix that indicates the attitude of the vehicle-mounted camera to be aimed, the attitude of the vehicle-mounted camera to be aimed can be estimated even more accurately.

In the above aspect, the target may include a first region (TB1) and a second region (TB2) different from the first region, and the aiming method may estimate the attitude of the vehicle-mounted camera to be aimed based on a part in the first camera image corresponding to the first region, a part in the second camera image corresponding to the second region, and the attitude of the vehicle-mounted camera whose attitude is known.

According to this aspect, even in a case where the entirety of the target is not accurately displayed in the first and second camera images (for example, in a case where a part of the target is distorted or a part of the target is outside the first or second camera image), the attitude of the vehicle-mounted camera to be aimed can be estimated with good accuracy.

In the above aspect, in the first camera image, the first region may be positioned closer to a central part of the first camera image than the second region is, and in the second camera image, the second region may be positioned closer to a central part of the second camera image than the first region is.

In general, there is a tendency that the distortion in a central part of the camera image is smaller than the distortion in a peripheral part of the camera image. According to the above aspect, by using the images in regions of the first and second camera images close to the central parts thereof (namely, the regions with small distortion), the attitude of the vehicle-mounted camera to be aimed can be estimated even more accurately.

In the above aspect, in the step of estimating the attitude of the vehicle-mounted camera to be aimed, the first region and the second region may be selected according to a selection criterion set for each vehicle.

According to this aspect, the first region and the second region can be properly selected according to the selection criterion set for each vehicle (for example, the vehicle type, aiming environment, etc.). Therefore, the attitude of the vehicle-mounted camera to be aimed can be estimated even more accurately.

In the above aspect, the second region may not be displayed in the first camera image, and the first region may not be displayed in the second camera image.

According to this aspect, even in a case where the common field of view of the vehicle-mounted camera whose attitude is known and the vehicle-mounted camera to be aimed (the region where the image capturing ranges overlap each other) is narrow and a part of the target is outside the first or second camera image, the attitude of the vehicle-mounted camera to be aimed can be estimated with good accuracy. Therefore, the degree of freedom of arrangement of the target can be enhanced.

To achieve the above object, one aspect of the present invention provides a non-transitory computer-readable storage medium, comprising a stored program, wherein the program, when executed by a processor (3), causes the processor to execute: a step (ST2, ST12) of acquiring a first camera image (I₁) by causing a vehicle-mounted camera whose attitude is known to capture an image of a target (TB); a step (ST3, ST13) of acquiring a second camera image (I₂) by causing a vehicle-mounted camera to be aimed, which is disposed such that an image capturing range of the vehicle-mounted camera to be aimed overlaps an image capturing range of the vehicle-mounted camera whose attitude is known, to capture an image of the target; and a step (ST4, ST15) of estimating an attitude of the vehicle-mounted camera to be aimed based on the first camera image, the second camera image, and an attitude of the vehicle-mounted camera whose attitude is known.

According to this aspect, the target may be set at any position where the image of the target can be captured by both the vehicle-mounted camera whose attitude is known and the vehicle-mounted camera to be aimed. Therefore, the restriction on the size of the space in which aiming of the vehicle-mounted camera is performed and the ground shape in such a space can be relaxed. Also, by estimating the attitude of the vehicle-mounted camera to be aimed based on the attitude of the vehicle-mounted camera whose attitude is known, the requirement for the positional accuracy of the target can be relaxed. Therefore, the setting process of the target can be simplified.

According to the above aspect, an aiming method for a vehicle-mounted camera and an aiming program which can relax the restriction on the size of the space in which aiming of the vehicle-mounted camera is performed and/or the ground shape can be provided.

### BRIEF DESCRIPTION OF THE DRAWINGS

FIG. 1 is a plan view showing an arrangement of vehicle-mounted cameras and a target board according to the first embodiment;

FIG. 2 is a block diagram showing the vehicle-mounted cameras and an aiming device according to the first embodiment;

FIG. 3 is a flowchart showing relative aiming according to the first embodiment;

FIG. 4 is a schematic diagram showing an external parameter matrix calculation process according to the first embodiment;

FIG. 5 is a schematic diagram showing an aiming method for a vehicle-mounted camera according to the second embodiment;

FIG. 6 is a schematic diagram showing an aiming method for a vehicle-mounted camera according to another embodiment;

FIGS. 7A and 7B are schematic diagrams showing an aiming method for a vehicle-mounted camera according to the third embodiment;

FIG. 8 is a table showing the weighting of external parameter matrices according to the third embodiment;

FIG. 9 is a flowchart showing the relative aiming according to the fourth embodiment;

FIG. 10 is a plan view showing an arrangement of the vehicle-mounted camera and the target board according to the fourth embodiment;

FIG. 11 is a schematic diagram showing the external parameter matrix calculation process according to the fourth embodiment;

FIG. 12 is a schematic diagram showing the external parameter matrix calculation process according to another embodiment;

FIG. 13 is a front view showing a target board according to the fifth embodiment;

FIGS. 14A and 14B are explanatory diagrams showing first and second camera images according to the fifth embodiment;

FIG. 15 is a schematic diagram showing an external parameter matrix calculation process according to the fifth embodiment; and

FIGS. 16A and 16B are explanatory diagrams showing first and second camera images according to another embodiment.

### DETAILED DESCRIPTION OF THE INVENTION

In the following, an aiming method for vehicle-mounted cameras Cp and an aiming program according to first to fourth embodiments of the present invention will be described with reference to the drawings. In the following, the terms “clockwise” and “counterclockwise” are used to refer to clockwise and counterclockwise directions in plan view. An arrow Fr included in some of the drawings indicates the forward direction of a vehicle 1.

### First Embodiment

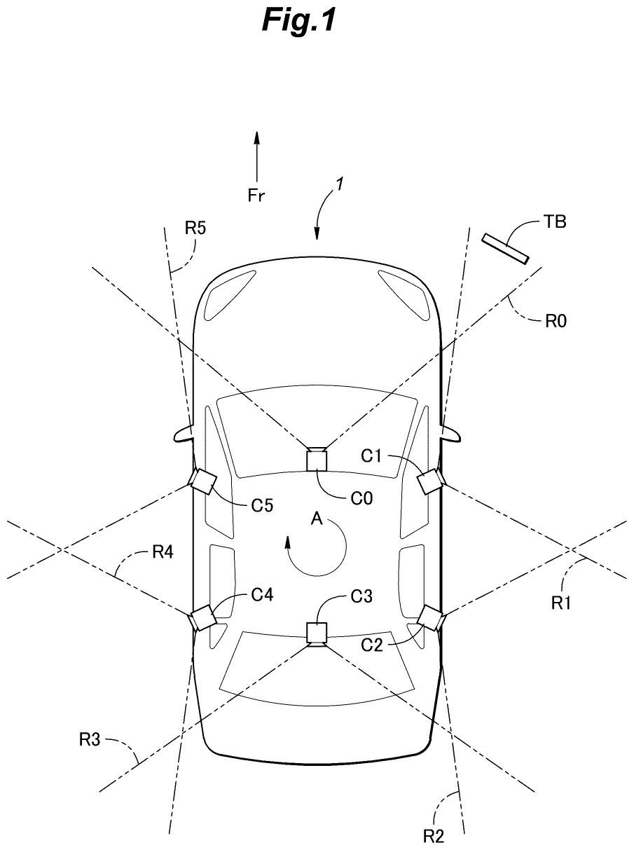

In the following, the first embodiment of the present invention will be described with reference to FIGS. 1 to 4.

### <Multiple Vehicle-Mounted Cameras Cp>

With reference to FIG. 1, multiple vehicle-mounted cameras Cp (p=0 to 5) are mounted on a vehicle 1 such as an automobile and capture images of the external environment of the vehicle 1. The image captured by each vehicle-mounted camera Cp (hereinafter referred to as “the camera image”) is used in an advanced driver assistance system (ADAS) of the vehicle 1. The camera images may be also used in autonomous driving (AD) of the vehicle 1.

The multiple vehicle-mounted cameras Cp include a front camera C0 mounted on the front surface of the vehicle 1, a front side camera C1 mounted on a front portion of the right side surface of the vehicle 1, a rear side camera C2 mounted on a rear portion of the right side surface of the vehicle 1, a rear camera C3 mounted on the rear surface of the vehicle 1, a rear side camera C4 mounted on a rear portion of the left side surface of the vehicle 1, and a front side camera C5 mounted on a front portion of the left side surface of the vehicle 1. As indicated by an arrow A in FIG. 1, the multiple vehicle-mounted cameras Cp are given numbers (labels) from 0 to 5 clockwise in order from the front camera C0.

Image capturing ranges Rp of the vehicle-mounted cameras Cp that are adjacent to each other partially overlap each other. For example, the image capturing range R0 of the front camera C0 and the image capturing range R1 of the front side camera C1 partially overlap each other.

### <Aiming Device 3>

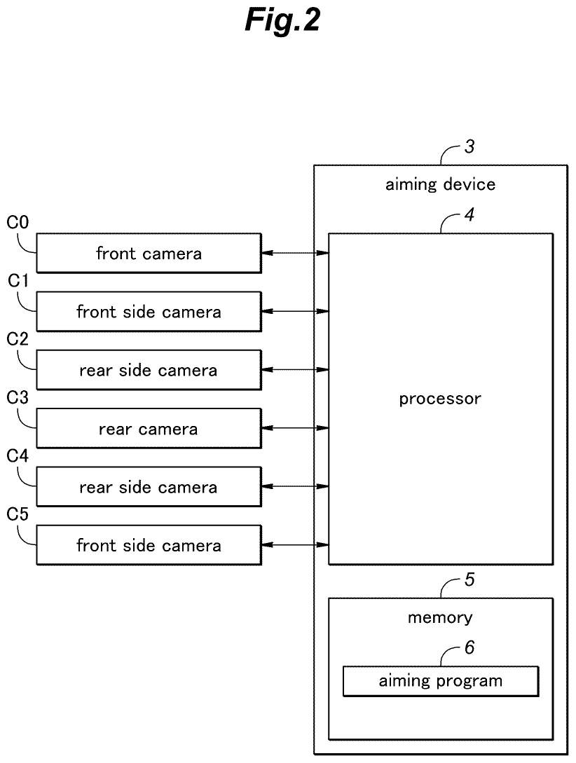

With reference to FIG. 2, the aiming device 3 is a device for performing later-described relative aiming of the vehicle-mounted cameras Cp. The aiming device 3 may be mounted on the vehicle 1 or may be provided outside the vehicle 1.

The aiming device 3 is constituted of a computer having a processor 4 and a memory 5. The processor 4 is composed of a CPU, an MPU, or the like. The processor 4 is connected to each vehicle-mounted camera Cp and acquires a camera image from each vehicle-mounted camera Cp. The memory 5 is composed of a ROM, a RAM, and the like. The memory 5 stores various programs executed by the processor 4. For example, the memory 5 stores an aiming program 6. With the processor 4 reading the aiming program 6 from the memory 5 and executing the same, part of the later-described relative aiming is performed (steps ST2 to ST4).

### <Aiming Method for Vehicle-Mounted Cameras Cp >

In the following, the coordinate system based on the vehicle 1 is referred to as a vehicle coordinate system, the coordinate system based on each vehicle-mounted camera Cp is referred to as a camera coordinate system, and the coordinate system based on a target board TB (one example of a target) is referred to as a board coordinate system (one example of a target coordinate system). In the following, when simply referred to as “attitude” or “position,” they indicate the attitude or position in the vehicle coordinate system.

The following formula (1) represents an external parameter matrix T_{Cp} of the vehicle-mounted camera Cp in the vehicle coordinate system (hereinafter simply referred to as “the external parameter matrix T_{Cp} of the vehicle-mounted camera Cp”). Here, R_{Cp} in the following formula (1) is a rotation matrix indicating the attitude (direction) of the vehicle-mounted camera Cp, and t_{Cp} in the following formula (1) is a translation vector indicating the position of the vehicle-mounted camera Cp. In the following formula (1), “mod 6” is the solution to a modulo operation (the remainder after dividing p by 6).

$${T}_{Cp} = ( \begin{matrix}{R}_{Cp} & {t}_{Cp} \\ 0 & 1\end{matrix} ) ( p = 0 , 1 , 2 , 3 , 4 , 5 mod 6 ) \qquad ( 1 )$$

When the vehicle 1 is shipped from the factory, absolute static aiming (hereinafter referred to as “absolute aiming”) is performed on the all vehicle-mounted cameras Cp. More specifically, in the state in which the vehicle 1 is stopped, individual aiming (estimation process of optical axis) is performed on the all vehicle-mounted cameras Cp by using the target board TB whose position in the vehicle coordinate system is known. Thereby, the external parameter matrices T_{Cp} of the all vehicle-mounted cameras Cp become known.

Thereafter, in a case where the attitude of some of the vehicle-mounted cameras Cp changes (for example, in a case where some of the vehicle-mounted cameras Cp are replaced), it becomes necessary to perform aiming of the some of the vehicle-mounted cameras Cp again. In such a case, in the present embodiment, the external parameter matrix T_{Cp} of each vehicle-mounted camera Cp to be aimed is estimated by performing relative static aiming (hereinafter referred to as “relative aiming”) between the vehicle-mounted camera C(p−1) whose external parameter matrix T_{C(p-1)} is known and the vehicle-mounted camera Cp to be aimed. In the following, such relative aiming will be described in detail.

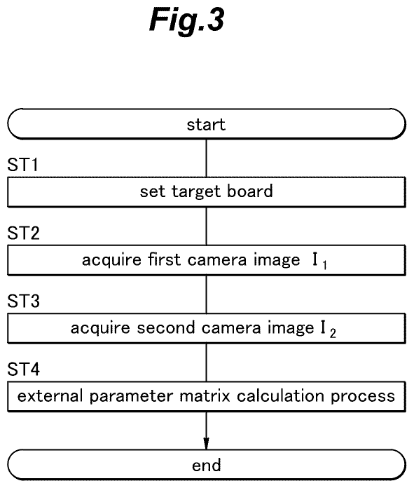

With reference to FIG. 3, first, the worker sets the target board TB in the overlapping part of the image capturing range R(p−1) of the vehicle-mounted camera C(p−1) and the image capturing range Rp of the vehicle-mounted camera Cp (step ST1).

With reference to FIG. 1, in a case where the relative aiming is performed between the front camera C0 and the front side camera C1, for example, the worker sets the target board TB in the overlapping part of the image capturing range R0 of the front camera C0 and the image capturing range R1 of the front side camera C1. The target board TB has multiple feature points i (i=1, 2, . . . , N). Note that in the state in which the target board TB is set by the worker, the three-dimensional coordinate of each feature point i in the vehicle coordinate system is unknown, but the three-dimensional coordinate bᵢ of each feature point i in the board coordinate system is known.

With reference to FIG. 3, next, the aiming device 3 causes the vehicle-mounted camera C(p−1) to capture an image of the target board TB and acquires a first camera image I₁ from the vehicle-mounted camera C(p−1) (step ST2). Also, the aiming device 3 causes the vehicle-mounted camera Cp to capture an image of the target board TB and acquires a second camera image I₂ from the vehicle-mounted camera Cp (step ST3). In another embodiment, the order of step ST2 and step ST3 may be reversed.

Next, the aiming device 3 executes an external parameter matrix calculation process (step ST4). In the external parameter matrix calculation process, the aiming device 3 calculates the external parameter matrix T_{Cp} of the vehicle-mounted camera Cp based on the first camera image I₁, the second camera image I₂, and the external parameter matrix T_{C(p-1)} of the vehicle-mounted camera C(p−1). In other words, in the external parameter matrix calculation process, the aiming device 3 estimates the attitude and position of the vehicle-mounted camera Cp. In the following, the external parameter matrix calculation process will be described in detail.

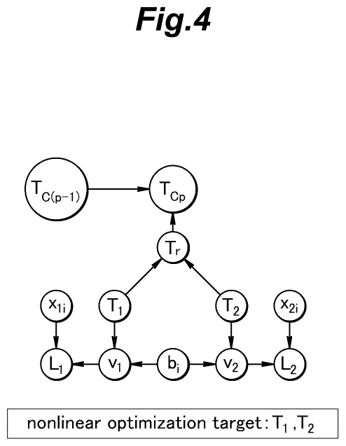

With reference to FIG. 4, the aiming device 3 extracts a two-dimensional coordinate x₁ᵢ of each feature point i of the target board TB from the first camera image I₁. Similarly, the aiming device 3 extracts a two-dimensional coordinate x₂ᵢ of each feature point i of the target board TB from the second camera image I₂. The aiming device 3 normalizes the extracted two-dimensional coordinates x₁ᵢ, x₂ᵢ.

The aiming device 3 calculates a three-dimensional vector v₁ by transforming the three-dimensional coordinate bᵢ of each feature point i of the target board TB in the board coordinate system with a transformation matrix T₁. The transformation matrix T₁ is a transformation matrix between the board coordinate system and the camera coordinate system regarding the vehicle-mounted camera C(p−1). The three-dimensional vector v₁ is a vector indicating the position of a point obtained by reprojecting each feature point i of the target board TB onto the first camera image I₁. More specifically, the aiming device 3 calculates the three-dimensional vector v₁ according to the following formula (2).

$$( \begin{matrix}{v}_{1} \\ 1\end{matrix} ) = {T}_{1} ( \begin{matrix}{b}_{i} \\ 1\end{matrix} ) \qquad ( 2 )$$

Similarly, the aiming device 3 calculates a three-dimensional vector v₂ by transforming the three-dimensional coordinate bᵢ of each feature point i of the target board TB in the board coordinate system with a transformation matrix T₂. The transformation matrix T₂ is a transformation matrix between the board coordinate system and the camera coordinate system regarding the vehicle-mounted camera Cp. The three-dimensional vector v₂ is a vector indicating the position of a point obtained by reprojecting each feature point i of the target board TB onto the second camera image I₂. More specifically, the aiming device 3 calculates the three-dimensional vector v₂ according to the following formula (3).

$$( \begin{matrix}{v}_{2} \\ 1\end{matrix} ) = {T}_{2} ( \begin{matrix}{b}_{i} \\ 1\end{matrix} ) \qquad ( 3 )$$

The aiming device 3 calculates a reprojection error L₁ in the first camera image I₁ based on the two-dimensional coordinate x₁ᵢ and the three-dimensional vector v₁. More specifically, the aiming device 3 calculates the reprojection error L₁ in the first camera image I₁ according to the following formulas (4) and (5). Here, L₁ᵢ in the formulas (4) and (5) indicates the reprojection error of each feature point i of the target board TB, v₁₁, v₁₂, and v₁₃ in the following formula (4) indicate the three coordinate components of the three-dimensional vector v₁, and x₁ᵢ₁ and x₁ᵢ₂ in the following formula (4) indicate the two coordinate components of the two-dimensional coordinate x₁ᵢ.

$${L}_{1 i} = {( \frac{{v}_{11}}{{v}_{13}} - {x}_{1 i 1} )}^{2} + {( \frac{{v}_{12}}{{v}_{13}} - {x}_{1 i 2} )}^{2} \qquad ( 4 )$$

$${L}_{1} = {{\sum }^{N}}_{i = 1} {L}_{1 i} \qquad ( 5 )$$

Similarly, the aiming device 3 calculates a reprojection error L₂ in the second camera image I₂ based on the two-dimensional coordinate x₂ᵢ and the three-dimensional vector v₂. More specifically, the aiming device 3 calculates the reprojection error L₂ in the second camera image I₂ according to the following formulas (6) and (7). Here, L₂ᵢ in the following formulas (6) and (7) indicates a reprojection error of each feature point i of the target board TB, v₂₁, v₂₂, and v₂₃ in the following formula (6) indicate the three coordinate components of the three-dimensional vector v₂, and x₂ᵢ₁ and x₂ᵢ₂ in the following formula (6) indicate the two coordinate components of the two-dimensional coordinate x₂ᵢ.

$${L}_{2 i} = {( \frac{{v}_{21}}{{v}_{23}} - {x}_{2 i 1} )}^{2} + {( \frac{{v}_{22}}{{v}_{23}} - {x}_{2 i 2} )}^{2} \qquad ( 6 )$$

$${L}_{2} = {\sum }_{i = 1}^{N} {L}_{2 i} \qquad ( 7 )$$

The aiming device 3 calculates the transformation matrix T₁ that minimizes the reprojection error L₁ by solving a PnP problem (Perspective-n-Point Problem) for the transformation matrix T₁ with nonlinear optimization (for example, Levenberg-Marquardt algorithm). Similarly, the aiming device 3 calculates the transformation matrix T₂ that minimizes the reprojection error L₂ by solving a PnP problem for the transformation matrix T₂ with nonlinear optimization.

As described above, the transformation matrix T₁ is a transformation matrix between the board coordinate system and the camera coordinate system regarding the vehicle-mounted camera C(p−1). Therefore, calculating the transformation matrix T₁ corresponds to estimating the relative attitude and position between the vehicle-mounted camera C(p−1) and the target board TB. Similarly, the transformation matrix T₂ is a transformation matrix between the board coordinate system and the camera coordinate system regarding the vehicle-mounted camera Cp. Therefore, calculating the transformation matrix T₂ corresponds to estimating the relative attitude and position between the vehicle-mounted camera Cp and the target board TB.

The aiming device 3 calculates a relative coordinate transformation matrix Tᵣ between the vehicle-mounted camera C(p−1) and the vehicle-mounted camera Cp based on the transformation matrices T₁, T₂. More specifically, the aiming device 3 calculates the relative coordinate transformation matrix Tᵣ between the vehicle-mounted camera C(p−1) and the vehicle-mounted camera Cp according to the following formula (8).

$${T}_{r} = {T}_{2} {T}_{1}^{- 1} \qquad ( 8 )$$

Calculating the relative coordinate transformation matrix Tᵣ between the vehicle-mounted camera C(p−1) and the vehicle-mounted camera Cp corresponds to estimating the relative attitude and position between the vehicle-mounted camera C(p−1) and the vehicle-mounted camera Cp.

The aiming device 3 calculates the external parameter matrix T_{Cp} of the vehicle-mounted camera Cp based on the relative coordinate transformation matrix Tᵣ and the external parameter matrix T_{C(p-1)} of the vehicle-mounted camera C(p−1). More specifically, the aiming device 3 calculates the external parameter matrix T_{Cp} of the vehicle-mounted camera Cp according to the following formula (9).

$${T}_{C p} = {T}_{r} {T}_{C ( p - 1 )} \qquad ( 9 )$$

Calculating the external parameter matrix T_{Cp} of the vehicle-mounted camera Cp corresponds to estimating the attitude and position of the vehicle-mounted camera Cp.

### Effects

In the present embodiment, the external parameter matrix T_{Cp} of the vehicle-mounted camera Cp to be aimed is estimated by performing the relative aiming between the vehicle-mounted camera C(p−1) whose external parameter matrix T_{C(p-1)} is known and the vehicle-mounted camera Cp to be aimed. Therefore, the target board TB may be set at any position where the image of the target board TB can be captured by both the vehicle-mounted camera C(p−1) whose attitude is known and the vehicle-mounted camera Cp to be aimed. Thus, the restriction on the size of the space in which the aiming of the vehicle-mounted camera Cp is performed and the ground shape in such a space can be relaxed.

Also, when the aforementioned absolute aiming is performed, high positional accuracy (for example, positional accuracy of a few millimeters) of the target board TB is required. In contrast to this, when the relative aiming is performed, the target board TB is only required to maintain relatively low positional accuracy (for example, positional accuracy of several tens centimeters). Thus, by adopting the relative aiming, the requirement for the positional accuracy of the target board TB can be relaxed, and the setting process of the target board TB can be simplified.

Further, when the relative aiming is performed, it is only required to set the target board TB in only the image capturing range Rp of each vehicle-mounted camera Cp to be aimed. Therefore, compared to the case where the absolute aiming is performed on the all vehicle-mounted cameras Cp, the number of times of setting the target board TB can be reduced.

### Modifications

In the present embodiment, the external parameter matrix T_{Cp} of the vehicle-mounted camera Cp is calculated based on the external parameter matrix T_{C(p-1)} of the vehicle-mounted camera C(p−1) by performing the relative aiming clockwise. In another embodiment, the external parameter matrix T_{Cp} of the vehicle-mounted camera Cp may be calculated based on the external parameter matrix T_{C(p+1)} of the vehicle-mounted camera C(p+1) by performing the relative aiming counterclockwise.

### Second Embodiment

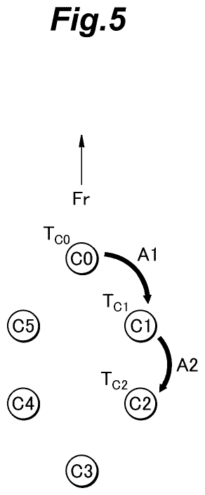

In the following, the second embodiment of the present invention will be described with reference to FIG. 5. Note that the features other than the aiming method for the vehicle-mounted cameras Cp are the same as the first embodiment, and thus, description thereof will be omitted.

In the present embodiment, description will be made of a method for calculating the external parameter matrices T_{Cp}, T_{C(p+1)} of the vehicle-mounted cameras Cp, C(p+1) to be aimed by performing multiple times of relative aiming consecutively, with the vehicle-mounted camera C(p−1) whose external parameter matrix T_{C(p-1)} is known being the starting point. Here, as one example, description will be made of a method for calculating the external parameter matrices T_{C1}, T_{C2} of the front side camera C1 and the rear side camera C2 by performing two times of relative aiming consecutively, with the front camera C0 being the starting point.

First, as indicated by the arrow A1 in FIG. 5, the worker and the aiming device 3 (hereinafter collectively referred to as “the aiming performer”) calculate the external parameter matrix T_{C1} of the front side camera C1 based on the external parameter matrix T_{C0} of the front camera C0 by performing the relative aiming between the front camera C0 and the front side camera C1. Thereby, the external parameter matrix T_{C1} of the front side camera C1 becomes known.

Next, as indicated by the arrow A2 in FIG. 5, the aiming performer calculates the external parameter matrix T_{C2} of the rear side camera C2 based on the external parameter matrix T_{C1} of the front side camera C1 by performing the relative aiming between the front side camera C1 and the rear side camera C2. The aiming performer may calculate the external parameter matrices T_{C3}, T_{C4}, and T_{C5} of the rear camera C3, the rear side camera C4, and the front side camera C5 with a similar procedure.

### Effects

In the present embodiment, the external parameter matrices T_{Cp}, T_{C(p+1)} of the vehicle-mounted cameras Cp, C(p+1) to be aimed are calculated by performing multiple times of relative aiming consecutively, with the vehicle-mounted camera C(p−1) whose external parameter matrix T_{C(p-1)} is known being the starting point. In other words, the attitude and position of the vehicle-mounted cameras Cp, C(p+1) to be aimed are estimated by performing multiple times of relative aiming consecutively, with the vehicle-mounted camera C(p−1) whose attitude and position are known being the starting point. Thereby, the attitude and position of the multiple vehicle-mounted cameras Cp, C(p+1) to be aimed can be estimated.

### Modifications

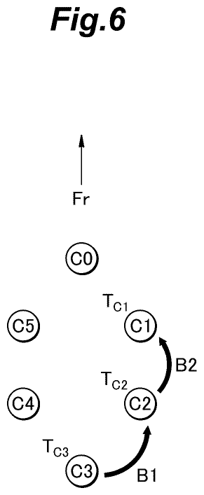

In the present embodiment, by performing multiple times of relative aiming consecutively clockwise, the external parameter matrices T_{Cp}, T_{C(p+1)} of the vehicle-mounted cameras Cp, C(p+1) are calculated based on the external parameter matrix T_{C(p-1)} of the vehicle-mounted camera C(p−1). In another embodiment, the external parameter matrices T_{Cp}, T_{C(p+1)} of the vehicle-mounted cameras Cp, C(p+1) may be calculated based on the external parameter matrix T_{C(p+2)} of the vehicle-mounted camera C(p+2) by performing multiple times of relative aiming consecutively counterclockwise. For example, as indicated by the arrows B1, B2 in FIG. 6, by performing two times of relative aiming consecutively counterclockwise, with the rear camera C3 being the starting point, the external parameter matrices T_{C2}, T_{C1} of the rear side camera C2 and the front side camera C1 may be calculated based on the external parameter matrix T_{C3} of the rear camera C3.

### Third Embodiment

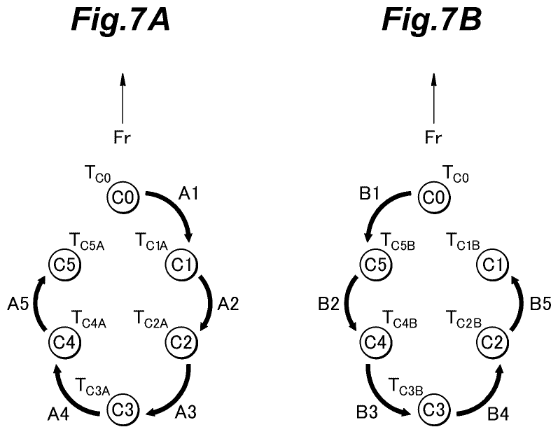

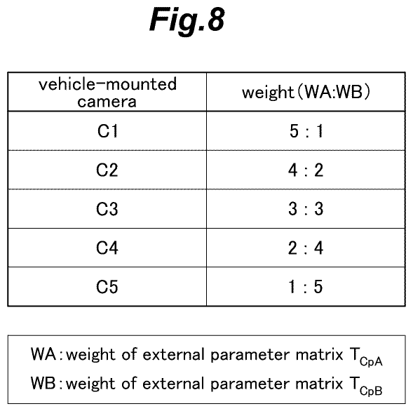

In the following, the third embodiment of the present invention will be described with reference to FIGS. 7A, 7B, and 8. Note that the features other than the aiming method for the vehicle-mounted cameras Cp are the same as the first embodiment, and thus, description thereof will be omitted.

In the present embodiment, description will be made of a method for calculating, based on the external parameter matrix T_{Cp} of one vehicle-mounted camera Cp (the vehicle-mounted camera Cp whose external parameter matrix T_{Cp} is known), the external parameter matrices T_{Cp} of the all other vehicle-mounted cameras Cp (the vehicle-mounted cameras Cp to be aimed) by performing multiple times of relative aiming consecutively. Here, as one example, description will be made of a method for calculating, based on the external parameter matrix T_{C0} of the front camera C0, the external parameter matrices T_{Cp} of the all other vehicle-mounted cameras Cp (p=1 to 5) by performing multiple times of relative aiming consecutively.

As indicated by the arrow A1 in FIG. 7A, the aiming performer calculates the external parameter matrix T_{C1} of the front side camera C1A based on the external parameter matrix T_{C0} of the front camera C0 by performing the relative aiming between the front camera C0 and the front side camera C1. Similarly, as indicated by the arrows A2 to A5 in FIG. 7A, the aiming performer calculates the external parameter matrices T_{C2A} to T_{C5A} of the rear side camera C2, the rear camera C3, the rear side camera C4, and the front side camera C5 by sequentially performing the relative aiming between the front side camera C1 and the rear side camera C2, between the rear side camera C2 and the rear camera C3, between the rear camera C3 and the rear side camera C4, and between the rear side camera C4 and the front side camera C5.

In this way, by performing multiple times of relative aiming consecutively clockwise with respect to the vehicle-mounted cameras Cp (p=1 to 5), with the front camera C0 being the starting point, the aiming performer calculates an external parameter matrix T_{CpA} of each vehicle-mounted camera Cp (first estimated values of the attitude and position of each vehicle-mounted camera Cp).

As indicated by the arrow B1 in FIG. 7B, the aiming performer calculates the external parameter matrix T_{C5B} of the front side camera C5 based on the external parameter matrix T_{C0} of the front camera C0 by performing the relative aiming between the front camera C0 and the front side camera C5. Similarly, as indicated by the arrows B2 to B5 in FIG. 7B, the aiming performer calculates the external parameter matrices T_{C4B} to T_{C1B} of the rear side camera C4, the rear camera C3, the rear side camera C2, and the front side camera C1 by sequentially performing the relative aiming between the front side camera C5 and the rear side camera C4, between the rear side camera C4 and the rear camera C3, between the rear camera C3 and the rear side camera C2, and between the rear side camera C2 and the front side camera C1.

In this way, by performing multiple times of relative aiming consecutively counterclockwise with respect to the vehicle-mounted cameras Cp (p=1 to 5), with the front camera C0 being the starting point, the aiming performer calculates an external parameter matrix T_{CpB} of each vehicle-mounted camera Cp (second estimated values of the attitude and position of each vehicle-mounted camera Cp).

The aiming device 3 decides the external parameter matrix T_{Cp} of each vehicle-mounted camera Cp (p=1 to 5) based on the external parameter matrices T_{CpA}, T_{CpB} of the vehicle-mounted camera Cp. In the following, the decision method is described.

### <Decision Method 1 of External Parameter Matrix T_{Cp}>

For each of the vehicle-mounted cameras Cp (p=1 to 5), the aiming device 3 selects, as the external parameter matrix T_{Cp} of the vehicle-mounted camera Cp, one of the external parameter matrices T_{CpA} and T_{CpB} that is calculated with a fewer times of relative aiming, with the front camera C0 being the starting point.

For example, the external parameter matrix T_{C1A} is calculated with one time of relative aiming (see the arrow A1 in FIG. 7A). In contrast, the external parameter matrix T_{C1B} is calculated with five times of relative aiming (see the arrows B1 to B5 in FIG. 7B). Thus, for the front side camera C1, the aiming device 3 selects the external parameter matrix T_{C1A} as the external parameter matrix T_{C1}. For a similar reason, for the rear side camera C2, the rear side camera C4, and the front side camera C5, the aiming device 3 selects the external parameter matrices T_{C2A}, T_{C4B}, and T_{C5B} as the external parameter matrices T_{C2}, T_{C4}, and T_{C5}, respectively.

Note that the external parameter matrices T_{C3A} and T_{C3B} are both calculated with three times of relative aiming (see the arrows A1 to A3 in FIG. 7A and the arrows B1 to B3 in FIG. 7B). Thus, for the rear camera C3, the aiming device 3 selects an arbitrary one (for example, the external parameter matrix T_{C3A}) of the external parameter matrices T_{C3A} and T_{C3B} as the external parameter matrix T_{C3}.

### <Decision Method 2 of External Parameter Matrix T_{Cp}>

With reference to FIG. 8, the aiming device 3 decides a weight WA of the external parameter matrix T_{CpA} of each vehicle-mounted camera Cp (p=1 to 5). Similarly, the aiming device 3 decides a weight WB of the external parameter matrix T_{CpB} of each vehicle-mounted camera Cp.

More specifically, the fewer the number of times of relative aiming with the front camera C0 being the starting point is, the greater the aiming device 3 makes the weights WA, WB of the external parameter matrices T_{CpA}, T_{CpB}. Thereby, one of the weights of the external parameter matrices T_{CpA}, T_{CpB} that is calculated with a fewer times of relative aiming becomes greater than the other.

For example, the external parameter matrix T_{C1A} is calculated with one time of relative aiming (see the arrow A1 in FIG. 7A). In contrast, the external parameter matrix T_{C1B} is calculated with five times of relative aiming (see the arrows B1 to B5 in FIG. 7B). Thus, for the front side camera C1, the aiming device 3 sets the weight WA of the external parameter matrix T_{C1A} to 5 and sets the weight WB of the external parameter matrix T_{C1B} to 1.

By performing weighted averaging on the external parameter matrices T_{CpA}, T_{CpB} of each vehicle-mounted camera Cp (p=1 to 5) based on the set weights WA, WB, the aiming device 3 decides the external parameter matrix T_{Cp} of each vehicle-mounted camera Cp. More specifically, the aiming device 3 decides the external parameter matrix T_{Cp} of each vehicle-mounted camera Cp according to the following formula (10).

$${T}_{{C}_{p}} = Weighted Average ( {T}_{{C}_{p A}} , {T}_{{C}_{p B}} , ( {w}_{A} , {w}_{B} ) ) \qquad ( 10 )$$

The weighted averaging here may adopt averaging using quaternion.

### Effects

In the present embodiment, the external parameter matrix T_{Cp} is decided based on the two estimated values (the external parameter matrices T_{CpA}, T_{CpB}). Therefore, even in the case where multiple times of relative aiming are performed consecutively, the external parameter matrix T_{Cp} can be decided with good accuracy.

### Modifications

In the present embodiment, aiming of multiple vehicle-mounted cameras Cp is started from a state in which the external parameter matrix T_{Cp} of one vehicle-mounted camera Cp is known. On the other hand, in another embodiment, there may be a case where aiming of multiple vehicle-mounted cameras Cp is started in a state in which none of the external parameter matrices T_{Cp} of the all vehicle-mounted cameras Cp is known. In such a case, the aiming performer may perform the above-described absolute aiming on one or more vehicle-mounted cameras Cp and may perform multiple times of relative aiming consecutively, with the vehicle-mounted camera Cp whose external parameter matrix T_{Cp} has become known by absolute aiming being the starting point. Namely, in another embodiment, both the absolute aiming and relative aiming may be used.

In the “decision method 1 of the external parameter matrix T_{Cp}” described above, which of the external parameter matrices T_{CpA}, T_{CpB} is to be selected is decided based on the number of times of relative aiming. In another embodiment, which of the external parameter matrices T_{CpA}, T_{CpB} is to be selected may be decided based on information other than the number of times of relative aiming (for example, the distance from the vehicle-mounted camera Cp whose attitude is known to the vehicle-mounted camera Cp to be aimed).

In the “decision method 2 of the external parameter matrix T_{Cp}” described above, based on the number of times of relative aiming, the weights WA, WB of the external parameter matrices T_{CpA}, T_{CpB} are decided. In another embodiment, the weights WA, WB of the external parameter matrices T_{CpA}, T_{CpB} may be decided based on information other than the number of times of relative aiming (for example, the distance from the vehicle-mounted camera Cp whose attitude is known to the vehicle-mounted camera Cp to be aimed).

### Fourth Embodiment

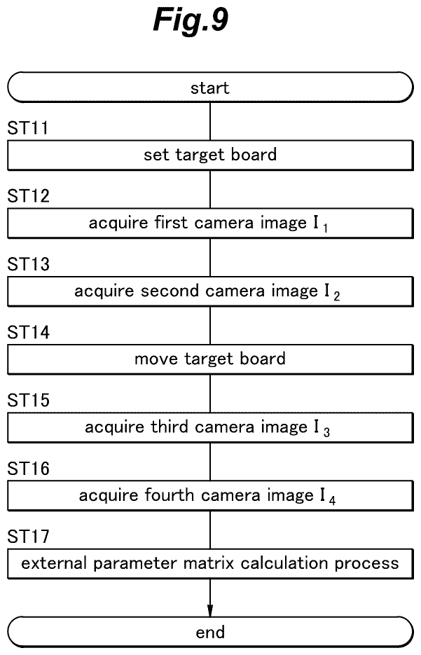

In the following, the fourth embodiment of the present invention will be described with reference to FIGS. 9 to 11. Note that the features other than the aiming method for the vehicle-mounted cameras Cp are the same as the first embodiment, and thus, description thereof will be omitted.

In the present embodiment, description will be made of a method for calculating the external parameter matrix T_{Cp} of the vehicle-mounted camera Cp to be aimed by performing the relative aiming between the vehicle-mounted cameras C(p−1), C(p+1) whose external parameter matrices T_{C(p-1)}, T_{C(p+1)} are known and the vehicle-mounted camera Cp to be aimed.

With reference to FIG. 9, the worker first sets the target board TB in the overlapping part of the image capturing range R(p−1) of the vehicle-mounted camera C(p−1) and the image capturing range Rp of the vehicle-mounted camera Cp (step ST11).

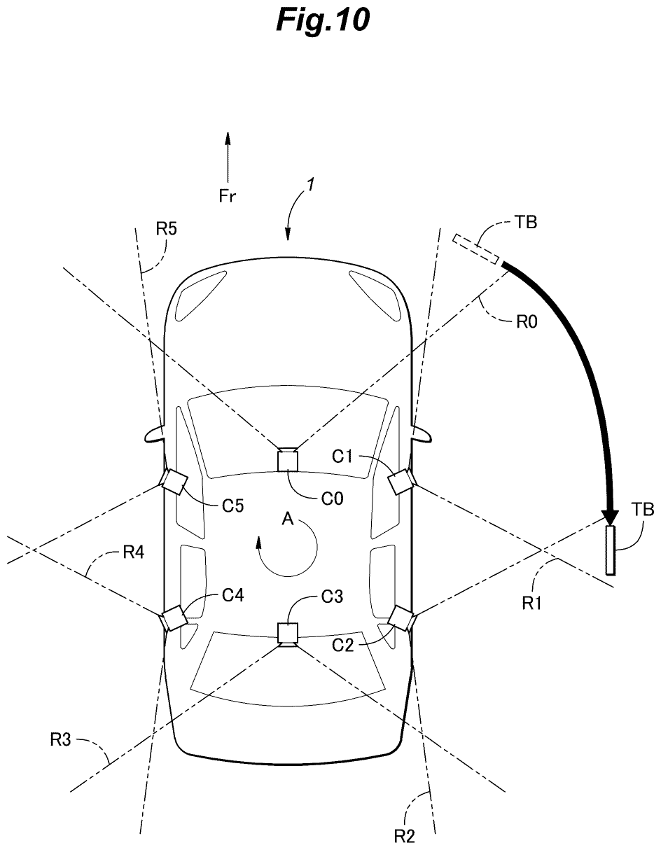

With reference to FIG. 10, for example, when performing the relative aiming between the front camera C0, the rear side camera C2 and the front side camera C1, the worker sets the target board TB in the overlapping part of the image capturing range R0 of the front camera C0 and the image capturing range R1 of the front side camera C1.

With reference to FIG. 9, next, the aiming device 3 causes the vehicle-mounted camera C(p−1) to capture an image of the target board TB and acquires a first camera image I₁ from the vehicle-mounted camera C(p−1) (step ST12). Also, the aiming device 3 causes the vehicle-mounted camera Cp to capture an image of the target board TB and acquires a second camera image I₂ from the vehicle-mounted camera Cp (step ST13).

Next, the worker moves the target board TB from the overlapping part of the image capturing range R(p−1) of the vehicle-mounted camera C(p−1) and the image capturing range Rp of the vehicle-mounted camera Cp to the overlapping part of the image capturing range Rp of the vehicle-mounted camera Cp and the image capturing range R(p+1) of the vehicle-mounted camera C(p+1) (step ST14).

With reference to FIG. 10, for example, when performing the relative aiming between the front camera C0, the rear side camera C2 and the front side camera C1, the worker moves the target board TB from the overlapping part of the image capturing range R0 of the front camera C0 and the image capturing range R1 of the front side camera C1 to the overlapping part of the image capturing range R1 of the front side camera C1 and the image capturing range R2 of the rear side camera C2.

With reference to FIG. 9, next, the aiming device 3 causes the vehicle-mounted camera Cp to capture an image of the target board TB and acquires a third camera image I₃ from the vehicle-mounted camera Cp (step ST15). Also, the aiming device 3 causes the vehicle-mounted camera C(p+1) to capture an image of the target board TB and acquires a fourth camera image I₄ from the vehicle-mounted camera C(p+1) (step ST16).

Next, the aiming device 3 executes an external parameter matrix calculation process (step ST17). In the external parameter matrix calculation process, the aiming device 3 calculates the external parameter matrix T_{Cp} of the vehicle-mounted camera Cp based on the first camera image I₁, the second camera image I₂, the third camera image I₃, the fourth camera image I₄, the external parameter matrix T_{C(p-1)} of the vehicle-mounted camera C(p−1), and the external parameter matrix T_{C(p+1)} of the vehicle-mounted camera C(p+1). In other words, in the external parameter matrix calculation process, the aiming device 3 estimates the attitude and position of the vehicle-mounted camera Cp. In the following, the external parameter matrix calculation process will be described in detail.

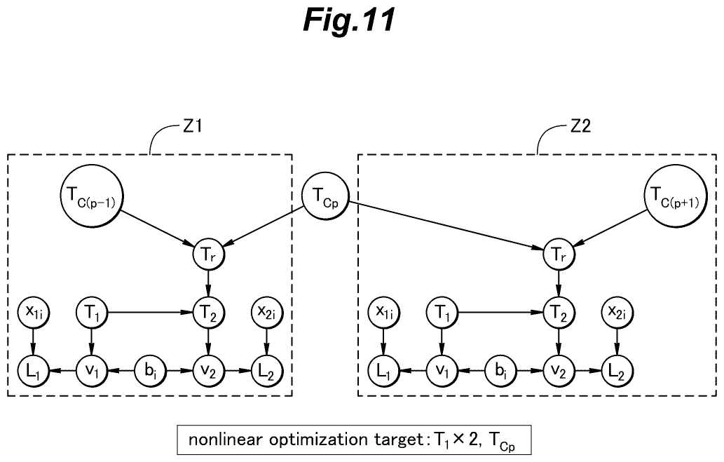

With reference to the region Z1 in FIG. 11, the aiming device 3 calculates a relative coordinate transformation matrix Tᵣ between the vehicle-mounted camera C(p−1) and the vehicle-mounted camera Cp based on the external parameter matrix T_{C(p-1)} of the vehicle-mounted camera C(p−1) and the external parameter matrix T_{Cp} of the vehicle-mounted camera Cp. More specifically, the aiming device 3 calculates the relative coordinate transformation matrix Tᵣ according to the following formula (11).

$${T}_{r} = {T}_{c ( p - 1 )} {T}_{c p}^{- 1} \qquad ( 11 )$$

The aiming device 3 calculates a transformation matrix T₂ based on the relative coordinate transformation matrix Tᵣ and the transformation matrix T₁. The transformation matrix T₁ is a transformation matrix between the board coordinate system and the camera coordinate system regarding the vehicle-mounted camera C(p−1). The transformation matrix T₂ is a transformation matrix between the board coordinate system and the camera coordinate system regarding the vehicle-mounted camera Cp. More specifically, the aiming device 3 calculates the transformation matrix T₂ according to the following formula (12).

$${T}_{2} = {T}_{r} {T}_{1} \qquad ( 12 )$$

The aiming device 3 calculates a three-dimensional vector v₁ by transforming the three-dimensional coordinate bᵢ of each feature point i of the target board TB in the board coordinate system with the transformation matrix T₁. The three-dimensional vector v₁ is a vector indicating the position of a point obtained by reprojecting each feature point i of the target board TB onto the first camera image I₁. More specifically, the aiming device 3 calculates the three-dimensional vector v₁ according to the following formula (13).

$$( \begin{matrix}{v}_{1} \\ 1\end{matrix} ) = {T}_{1} ( \begin{matrix}{b}_{i} \\ 1\end{matrix} ) \qquad ( 13 )$$

Similarly, the aiming device 3 calculates a three-dimensional vector v₂ by transforming the three-dimensional coordinate bᵢ of each feature point i of the target board TB in the board coordinate system with the transformation matrix T₂. The three-dimensional vector v₂ is a vector indicating the position of a point obtained by reprojecting each feature point i of the target board TB onto the second camera image I₂. More specifically, the aiming device 3 calculates the three-dimensional vector v₂ according to the following formula (14).

$$( \begin{matrix}{v}_{2} \\ 1\end{matrix} ) = {T}_{2} ( \begin{matrix}{b}_{i} \\ 1\end{matrix} ) = {T}_{r} {T}_{1} ( \begin{matrix}{b}_{i} \\ 1\end{matrix} ) = {T}_{C ( p - 1 )} {T}_{Cp}^{- 1} {T}_{1} ( \begin{matrix}{b}_{i} \\ 1\end{matrix} ) = {T}_{C ( p - 1 )} {T}_{Cp}^{- 1} {v}_{1} \qquad ( 14 )$$

The aiming device 3 extracts a two-dimensional coordinate x₁ᵢ of each feature point i of the target board TB from the first camera image I₁. Similarly, the aiming device 3 extracts a two-dimensional coordinate x₂ᵢ of each feature point i of the target board TB from the second camera image I₂.

The aiming device 3 calculates a reprojection error L₁ in the first camera image I₁ based on the two-dimensional coordinate x₁ᵢ and the three-dimensional vector v₁. Similarly, the aiming device 3 calculates a reprojection error L₂ in the second camera image I₂ based on the two-dimensional coordinate x₂ᵢ and the three-dimensional vector v₂. The calculation method of the reprojection errors L₁, L₂ is the same as the first embodiment, and thus, description thereof is omitted.

With reference to the region Z2 in FIG. 11, the aiming device 3 calculates a relative coordinate transformation matrix Tᵣ between the vehicle-mounted camera C(p+1) and the vehicle-mounted camera Cp based on the external parameter matrix T_{C(p+1)} of the vehicle-mounted camera C(p+1) and the external parameter matrix T_{Cp} of the vehicle-mounted camera Cp. More specifically, the aiming device 3 calculates the relative coordinate transformation matrix Tᵣ according to the following formula (15).

$${T}_{r} = {T}_{c ( p + 1 )} {T}_{c p}^{- 1} \qquad ( 15 )$$

The aiming device 3 calculates a transformation matrix T₂ based on the relative coordinate transformation matrix Tᵣ and the transformation matrix T₁. The transformation matrix T₁ is a transformation matrix between the board coordinate system and the camera coordinate system regarding the vehicle-mounted camera C(p+1). The transformation matrix T₂ is a transformation matrix between the board coordinate system and the camera coordinate system regarding the vehicle-mounted camera Cp. More specifically, the aiming device 3 calculates the transformation matrix T₂ according to the following formula (16).

$${T}_{2} = {T}_{r} {T}_{1} \qquad ( 16 )$$

The aiming device 3 calculates a three-dimensional vector v₁ by transforming the three-dimensional coordinate bᵢ of each feature point i of the target board TB in the board coordinate system with the transformation matrix T₁. The three-dimensional vector v₁ is a vector indicating the position of a point obtained by reprojecting each feature point i of the target board TB onto the fourth camera image I₄. More specifically, the aiming device 3 calculates the three-dimensional vector v₁ according to the following formula (17).

$$( \begin{matrix}{v}_{1} \\ 1\end{matrix} ) = {T}_{1} ( \begin{matrix}{b}_{i} \\ 1\end{matrix} ) \qquad ( 17 )$$

Similarly, the aiming device 3 calculates a three-dimensional vector v₂ by transforming the three-dimensional coordinate bᵢ of each feature point i of the target board TB in the board coordinate system with the transformation matrix T₂. The three-dimensional vector v₂ is a vector indicating the position of a point obtained by reprojecting each feature point i of the target board TB onto the third camera image I₃. More specifically, the aiming device 3 calculates the three-dimensional vector v₂ according to the following formula (18).

$$( \begin{matrix}{v}_{2} \\ 1\end{matrix} ) = {T}_{2} ( \begin{matrix}{b}_{i} \\ 1\end{matrix} ) = {T}_{r} {T}_{1} ( \begin{matrix}{b}_{i} \\ 1\end{matrix} ) = {T}_{C ( p - 1 )} {T}_{Cp}^{- 1} {T}_{1} ( \begin{matrix}{b}_{i} \\ 1\end{matrix} ) = {T}_{C ( p - 1 )} {T}_{Cp}^{- 1} {v}_{1} \qquad ( 18 )$$

The aiming device 3 extracts a two-dimensional coordinate x₁ᵢ of each feature point i of the target board TB from the fourth camera image I₄. Similarly, the aiming device 3 extracts a two-dimensional coordinate x₂ᵢ of each feature point i of the target board TB from the third camera image I₃.

The aiming device 3 calculates a reprojection error L₁ in the fourth camera image I₄ based on the two-dimensional coordinate x₁ᵢ and the three-dimensional vector v₁. Similarly, the aiming device 3 calculates a reprojection error L₂ in the third camera image I₃ based on the two-dimensional coordinate x₂ᵢ and the three-dimensional vector v₂. The calculation method of the reprojection errors L₁, L₂ is the same as the first embodiment, and thus, description thereof is omitted.

The aiming device 3 performs nonlinear optimization simultaneously on the two transformation matrices T₁ and the external parameter matrix T_{Cp} calculated in the regions Z1, Z2 of FIG. 11. Thereby, the aiming device 3 simultaneously calculates the two transformation matrices T₁ and the external parameter matrix T_{Cp} that minimize the reprojection errors L₁, L₂ calculated in each of the regions Z1, Z2 of FIG. 11. For example, the aiming device 3 converts a rotation matrix R_{Cp} (see the formula (1) mentioned above) in the external parameter matrix T_{Cp} to a rotation vector, and then performs the aforementioned nonlinear optimization by quasi-Newton method. In another embodiment, the aiming device 3 may perform the aforementioned nonlinear optimization by a method other than quasi-Newton method (for example, Levenberg-Marquardt algorithm).

### Effects

In the present embodiment, the clockwise estimation process and the counterclockwise estimation process of the external parameter matrix T_{Cp} of the vehicle-mounted camera Cp to be aimed are integrated, and nonlinear optimization is performed directly on the external parameter matrix T_{Cp}. Therefore, the external parameter matrix T_{Cp} can be estimated even more accurately.

### Modifications

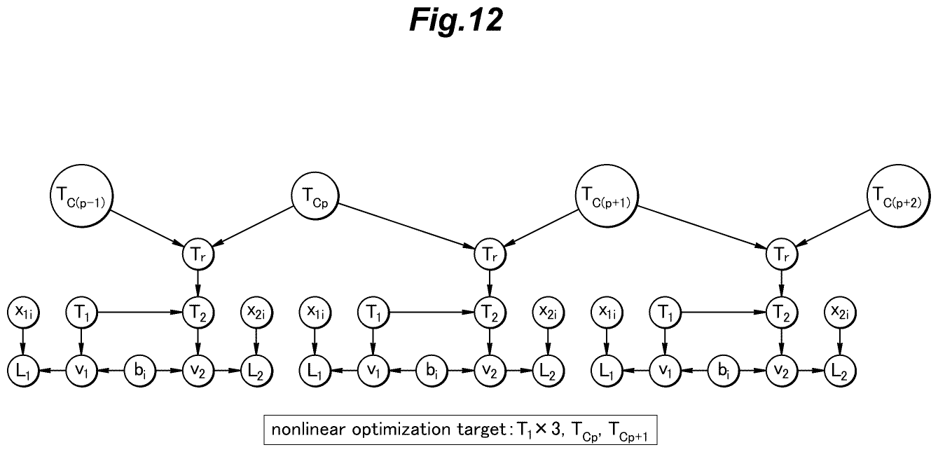

In the present embodiment, nonlinear optimization is performed directly on the external parameter matrix T_{Cp} of one vehicle-mounted camera Cp to be aimed. As shown in FIG. 12, in another embodiment, nonlinear optimization may be performed directly on the external parameter matrices T_{Cp}, T_{C(p+1)} of two vehicle-mounted cameras Cp, C(p+1) to be aimed. Further, in another embodiment, nonlinear optimization may be performed directly on the external parameter matrices T_{Cp} of three or more vehicle-mounted cameras Cp to be aimed. In a case where there are n number of vehicle-mounted cameras Cp to be aimed, the number of external parameter matrices T_{Cp} of the vehicle-mounted cameras Cp to be aimed is n, and the number of transformation matrices T₁ is n+1. Therefore, nonlinear optimization is performed simultaneously on the total of 2n+1 number of matrices (six degrees of freedom).

### Fifth Embodiment

In the following, the fifth embodiment of the present invention will be described with reference to FIGS. 9 and 13 to 16B. Note that the flow of the aiming method for the vehicle-mounted cameras Cp according to the fifth embodiment is the same as the flow of the aiming method for the vehicle-mounted cameras Cp according to the fourth embodiment. Therefore, in the following description, FIG. 9 which was used to describe the aiming method for the vehicle-mounted cameras Cp according to the fourth embodiment is used. Also, description of contents same as the fourth embodiment may be omitted as appropriate.

In the present embodiment, description will be made of a method for calculating the external parameter matrix T_{Cp} of the vehicle-mounted camera Cp by performing the relative aiming between the vehicle-mounted cameras C(p−1), C(p+1) whose external parameter matrices T_{C(p-1)}, T_{C(p+1)} are known and the vehicle-mounted camera Cp to be aimed.

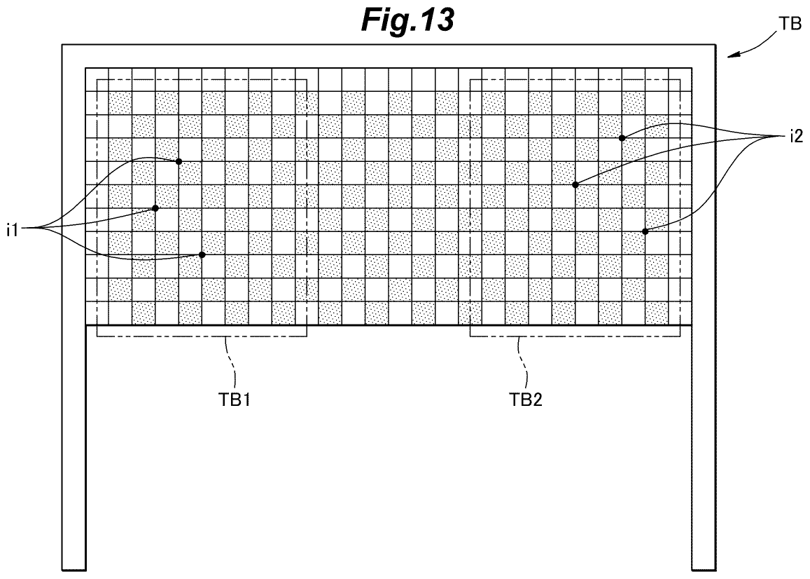

With reference to FIG. 9, the worker first sets the target board TB in the overlapping part of the image capturing range R(p−1) of the vehicle-mounted camera C(p−1) and the image capturing range Rp of the vehicle-mounted camera Cp (step ST11). With reference to FIG. 13, the target board TB includes a first region TB1 (for example, one of left and right regions) and a second region TB2 different from the first region TB1 (for example, the other of left and right regions). The first region TB1 includes multiple first feature points i1, and the second region TB2 includes multiple second feature points i2.

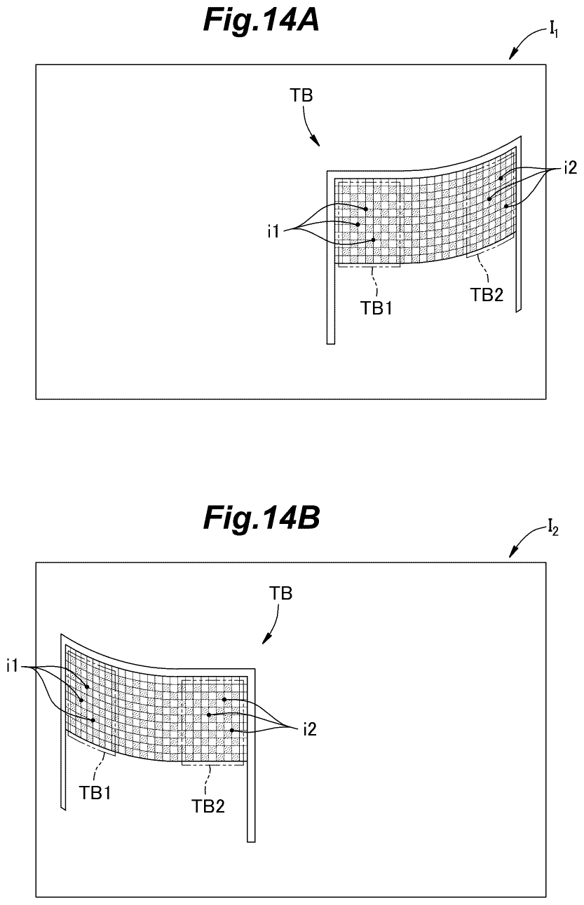

With reference to FIG. 9, next, the worker acquires first to fourth camera images I₁ to I₄ by the same procedure as the fourth embodiment (steps ST12 to ST16). With reference to FIG. 14A, in the first camera image I₁, the first region TB1 is positioned closer to the laterally central part of the first camera image I₁ than the second region TB2 is. With reference to FIG. 14B, in the second camera image I₂, the second region TB2 is positioned to the laterally central part of the second camera image I₂ than the first region TB1 is.

With reference to FIG. 9, next, the worker executes an external parameter matrix calculation process (step ST17). In the external parameter matrix calculation process, the aiming device 3 calculates the external parameter matrix T_{Cp} of the vehicle-mounted camera Cp based on a part of the first camera image I₁ corresponding to the first region TB1, a part of the second region TB2 corresponding to the second camera image I₂, the third camera image I₃, the fourth camera image I₄, the external parameter matrix T_{C(p-1)} of the vehicle-mounted camera C(p−1), and the external parameter matrix T_{C(p+1)} of the vehicle-mounted camera C(p+1). In other words, in the external parameter matrix calculation process, the aiming device 3 estimates the attitude and position of the vehicle-mounted camera Cp to be aimed based on the part of the first camera image I₁ corresponding to the first region TB1, the part of the second camera image I₂ corresponding to the second region TB2, and the attitude of the vehicle-mounted cameras C(p−1), C(p+1) whose attitude and position are known. In the following, the external parameter matrix calculation process will be described in detail.

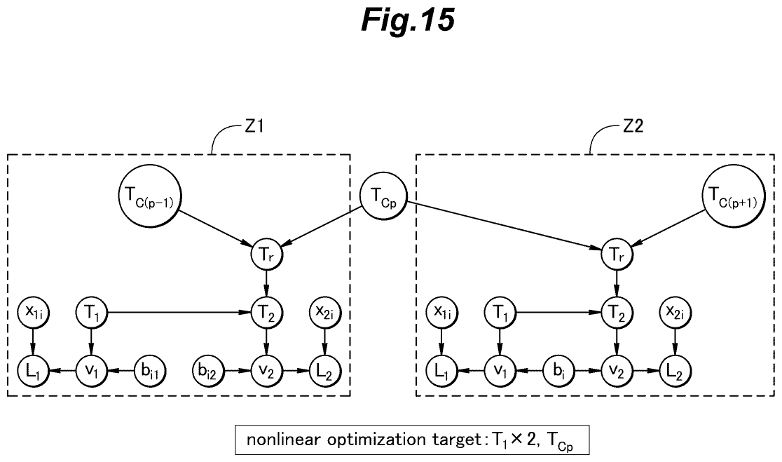

With reference to the region Z1 in FIG. 15, the aiming device 3 calculates a relative coordinate transformation matrix Tᵣ between the vehicle-mounted camera C(p−1) and the vehicle-mounted camera Cp based on the external parameter matrix T_{C(p-1)} of the vehicle-mounted camera C(p−1) and the external parameter matrix T_{Cp} of the vehicle-mounted camera Cp. Also, the aiming device 3 calculates a transformation matrix T₂ based on the relative coordinate transformation matrix Tᵣ and the transformation matrix T₁. The transformation matrix T₁ is a transformation matrix between the board coordinate system and the camera coordinate system regarding the vehicle-mounted camera C(p−1). The transformation matrix T₂ is a transformation matrix between the board coordinate system and the camera coordinate system regarding the vehicle-mounted camera Cp.

The aiming device 3 calculates a three-dimensional vector v₁ by transforming the three-dimensional coordinate bᵢ₁ of each first feature point i1 of the first region TB1 in the board coordinate system with the transformation matrix T₁. The three-dimensional vector v₁ is a vector indicating the position of a point obtained by reprojecting each first feature point i1 of the first region TB1 onto the first camera image I₁.

Similarly, the aiming device 3 calculates a three-dimensional vector v₂ by transforming the three-dimensional coordinate bᵢ₂ of each second feature point i2 of the second region TB2 in the board coordinate system with the transformation matrix T₂. The three-dimensional vector v₂ is a vector indicating the position of a point obtained by reprojecting each second feature point i2 of the second region TB2 onto the second camera image I₂.

The aiming device 3 extracts a two-dimensional coordinate x₁ᵢ of each first feature point i1 of the first region TB1 from the first camera image I₁. Similarly, the aiming device 3 extracts a two-dimensional coordinate x₂ᵢ of each second feature point i2 of the second region TB2 from the second camera image I₂.

The aiming device 3 calculates a reprojection error L₁ in the first camera image I₁ based on the two-dimensional coordinate x₁ᵢ and the three-dimensional vector v₁. Similarly, the aiming device 3 calculates a reprojection error L₂ in the second camera image I₂ based on the two-dimensional coordinate x₂ᵢ and the three-dimensional vector v₂.

For the region Z2 in FIG. 15, the aiming device 3 calculates transformation matrices T₁, T₂ and reprojection errors L₁, L₂ by the same method as that used for the region Z2 in the external parameter matrix calculation process according to the fourth embodiment (see FIG. 11).

The aiming device 3 performs nonlinear optimization simultaneously on the two transformation matrices T₁ and the external parameter matrix T_{Cp} calculated in the regions Z1, Z2 of FIG. 15. Thereby, the aiming device 3 simultaneously calculates the two transformation matrices T₁ and the external parameter matrix T_{Cp} that minimize the reprojection errors L₁, L₂ calculated in each of the regions Z1, Z2 of FIG. 15.

### Effects

With reference to FIG. 13, since the first and second feature points i1, i2 are present in the same target board TB, the relative positional relationship between the first and second feature points i1, i2 in the board coordinate system is known. Therefore, similarly to the case where the external parameter matrix T_{Cp} of the vehicle-mounted camera Cp is calculated by using the common feature points i of the target board TB (see the fourth embodiment), the external parameter matrix T_{Cp} of the vehicle-mounted camera Cp can be calculated by using the first and second feature points i1, i2. As described above, by calculating the external parameter matrix T_{Cp} by using the first and second feature points i1, i2 (namely, different sets of feature points in the target board TB), the external parameter matrix T_{Cp} of the vehicle-mounted camera Cp can be calculated with good accuracy even in a case where the entirety of the target board TB is not accurately displayed in the first and second camera images I₁, I₂ (for example, in a case where a part of the target board TB is distorted or in a case where a part of the target board TB is outside the camera image).

### Modifications

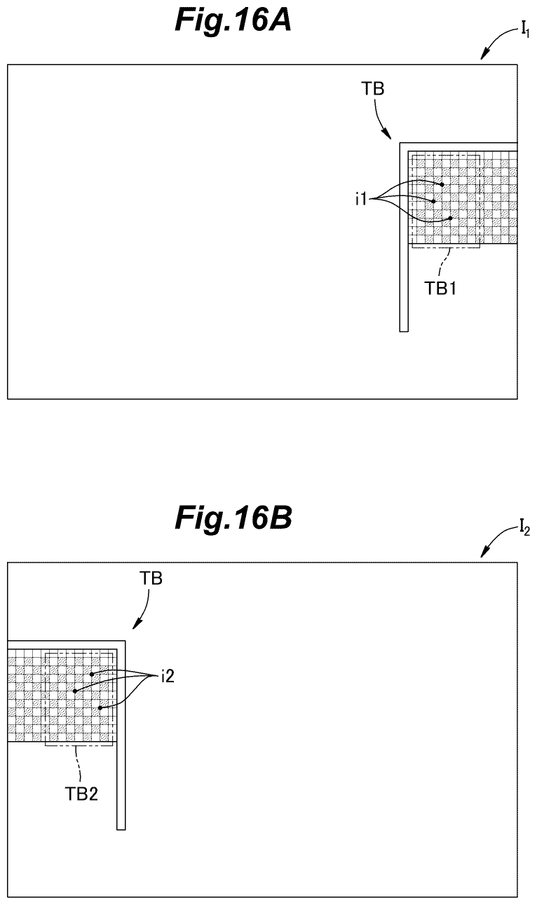

In the present embodiment, as shown in FIGS. 14A and 14B, the entirety of the target board TB is displayed in the first and second camera images I₁, I₂. In another embodiment, as shown in FIG. 16A, only the first region TB1 of the target board TB may be displayed in the first camera image I₁, and the second region TB2 of the target board TB may not be displayed in the first camera image I₁. Also, as shown in FIG. 16B, only the second region TB2 of the target board TB may be displayed in the second camera image I₂, and the first region TB1 of the target board TB may not be displayed in the second camera image I₂.

In the present embodiment, one of left and right regions of the target board TB is defined as the first region TB1 of the target board TB, and the other of left and right regions of the target board TB is defined as the second region TB2 of the target board TB. In another embodiment, one of upper and lower regions of the target board TB may be defined as the first region TB1 of the target board TB, and the other of upper and lower regions of the target board TB may be defined as the second region TB2 of the target board TB. Further, in another embodiment, the first region TB1 and the second region TB2 may be selected according to a selection criterion set for each vehicle 1 (for example, the type of the vehicle 1, aiming environment, etc.).

In the present embodiment, the calculation method using the first and second feature points i1, i2 (namely, different sets of feature points in the target board TB) of the target board TB is applied to the region Z1 in FIG. 15. In another embodiment, the calculation method using the first and second feature points i1, i2 of the target board TB may be applied to both the regions Z1, Z2 in FIG. 15. Further, in another embodiment, the calculation method using the first and second feature points i1, i2 of the target board TB may be applied to the external parameter matrix calculation process of the first embodiment (see FIG. 4).

In the first to fifth embodiments described above, the external parameter matrix T_{Cp} (attitude and position) of the vehicle-mounted camera Cp to be aimed is estimated by relative aiming. In another embodiment, only the rotation matrix R_{Cp} (attitude) of the external parameter matrix T_{Cp} of the vehicle-mounted camera Cp to be aimed may be estimated by relative aiming.

Concrete embodiments have been described in the foregoing but the present invention may be modified or altered in various ways without being limited by the above embodiments or modifications.

1. An aiming method for a vehicle-mounted camera, the aiming method comprising performing relative aiming, wherein the relative aiming comprises:
a step of acquiring a first camera image by causing a vehicle-mounted camera whose attitude is known to capture an image of a target;
a step of acquiring a second camera image by causing a vehicle-mounted camera to be aimed, which is disposed such that an image capturing range of the vehicle-mounted camera to be aimed overlaps an image capturing range of the vehicle-mounted camera whose attitude is known, to capture an image of the target; and
a step of estimating an attitude of the vehicle-mounted camera to be aimed based on the first camera image, the second camera image, and an attitude of the vehicle-mounted camera whose attitude is known.

2. The aiming method for a vehicle-mounted camera according to claim 1, wherein multiple times of the relative aiming are performed consecutively, with the vehicle-mounted camera whose attitude is known being a starting point.

3. The aiming method for a vehicle-mounted camera according to claim 2, the aiming method comprising:
calculating a first estimated value of the attitude of the vehicle-mounted camera to be aimed by performing the relative aiming clockwise with respect to the vehicle-mounted camera to be aimed,
calculating a second estimated value of the attitude of the vehicle-mounted camera to be aimed by performing the relative aiming counterclockwise with respect to the vehicle-mounted camera to be aimed, and
estimating the attitude of the vehicle-mounted camera to be aimed based on the first estimated value and the second estimated value.

4. The aiming method for a vehicle-mounted camera according to claim 3, wherein in the step of estimating the attitude of the vehicle-mounted camera to be aimed, either the first estimated value or the second estimated value is selected according to a predetermined rule.

5. The aiming method for a vehicle-mounted camera according to claim 4, wherein in the step of estimating the attitude of the vehicle-mounted camera to be aimed, one of the first estimated value and the second estimated value that is calculated with a fewer times of the relative aiming is selected.

6. The aiming method for a vehicle-mounted camera according to claim 3, wherein in the step of estimating the attitude of the vehicle-mounted camera to be aimed, weighted averaging is performed on the first estimated value and the second estimated value.

7. The aiming method for a vehicle-mounted camera according to claim 6, wherein in the weighted averaging, a weight of one of the first estimated value and the second estimated value that is calculated with a fewer times of the relative aiming is made greater than a weight of another of the first estimated value and the second estimated value.

8. The aiming method for a vehicle-mounted camera according to claim 1, wherein the step of estimating the attitude of the vehicle-mounted camera to be aimed comprises:
a step of estimating a relative attitude between the vehicle-mounted camera whose attitude is known and the target based on the first camera image;
a step of estimating a relative attitude between the vehicle-mounted camera to be aimed and the target based on the second camera image;
a step of estimating a relative attitude between the vehicle-mounted camera whose attitude is known and the vehicle-mounted camera to be aimed based on the relative attitude between the vehicle-mounted camera whose attitude is known and the target and the relative attitude between the vehicle-mounted camera to be aimed and the target; and
a step of estimating the attitude of the vehicle-mounted camera to be aimed based on the relative attitude between the vehicle-mounted camera whose attitude is known and the vehicle-mounted camera to be aimed and the attitude of the vehicle-mounted camera whose attitude is known.

9. The aiming method for a vehicle-mounted camera according to claim 1, wherein in the step of estimating the attitude of the vehicle-mounted camera to be aimed, nonlinear optimization is performed directly on an external parameter matrix of the vehicle-mounted camera to be aimed.

10. The aiming method for a vehicle-mounted camera according to claim 1, wherein the target includes a first region and a second region different from the first region, and
the aiming method estimates the attitude of the vehicle-mounted camera to be aimed based on a part in the first camera image corresponding to the first region, a part in the second camera image corresponding to the second region, and the attitude of the vehicle-mounted camera whose attitude is known.

11. The aiming method for a vehicle-mounted camera according to claim 10, wherein in the first camera image, the first region is positioned closer to a central part of the first camera image than the second region is, and
in the second camera image, the second region is positioned closer to a central part of the second camera image than the first region is.

12. The aiming method for a vehicle-mounted camera according to claim 10, wherein in the step of estimating the attitude of the vehicle-mounted camera to be aimed, the first region and the second region are selected according to a selection criterion set for each vehicle.

13. The aiming method for a vehicle-mounted camera according to claim 10, wherein the second region is not displayed in the first camera image, and
the first region is not displayed in the second camera image.

14. A non-transitory computer-readable storage medium, comprising a stored program, wherein the program, when executed by a processor, causes the processor to execute:
a step of acquiring a first camera image by causing a vehicle-mounted camera whose attitude is known to capture an image of a target;
a step of acquiring a second camera image by causing a vehicle-mounted camera to be aimed, which is disposed such that an image capturing range of the vehicle-mounted camera to be aimed overlaps an image capturing range of the vehicle-mounted camera whose attitude is known, to capture an image of the target; and
a step of estimating an attitude of the vehicle-mounted camera to be aimed based on the first camera image, the second camera image, and an attitude of the vehicle-mounted camera whose attitude is known.
